(19) United States
(12) Patent Application Publication
(10) Pub. No.: US 2004/0181581 A1
(43) Pub. Date: Sep. 16, 2004

(54) Authentication method for preventing delivery of junk electronic mail

(76) Inventor: Michael Thomas Kosco, San Clemente, CA (US)

Correspondence Address: THOMAS J. KOSCO, 26521 MONTEBELLO PL., MISSION VIEJO, CA, 92691, US

(21) Appl. No.: 10/386,033

(22) Filed: Mar. 11, 2003

(51) Int. Cl. G06F 15/16

(52) U.S. Cl. 709/206

(57) ABSTRACT

This invention relates to the field of Electronic Mail Systems. Specifically, this invention creates a new and useful method, a system and an unique computer program product for preventing delivery of undesirable (junk or spam) electronic mail messages to intended recipients. This invention authenticates the source address of every incoming electronic mail message, enabling the recipient to receive electronic e-mail only from trusted sources. This invention does not use predetermined lists, text-scanning filters or trusted-user-classification methods. Instead, it uses proprietary messaging feedback algorithms to authenticate the source address of each message, including but not limited to the sender's e-mail address.

### BACKGROUND OF THE INVENTION

Electronic mail, e-mail as it is popularly known, is an increasingly ubiquitous method of providing quick and convenient intercommunications between computer users. A message sender initiates the communication process by composing a message using a text editing program, inserting an e-mail address(es) of the intended recipient(s), and usually providing an indication of the content of the message by including text in a “Subject” field. Then, using well-understood technology, the originator's e-mail application sends the message to the recipient's e-mail address, usually via intermediary mail server computers, on the destination mail server where the recipient's mailbox resides. The recipient's e-mail client application, running on the recipient's computer periodically interrogates the mail server, checking for new messages addressed to the recipient. If new messages are present, the messages are retrieved (downloaded) and stored in the recipient's mail inbox. The recipient eventually reads, deletes, responds to, or otherwise processes messages stored within the computer's inbox, using any of a number of e-mail programs well known in the art.

Because these messages travel across networks, they generally are constructed according to the Standard for the Format of ARPA Internet Text Messages (RFC2822). This specification can be found on the world wide web of the Internet at address “http://www.cis.ohio-state.edu/cgi-bin/rfc/rfc2822.txt”. A message formatted to the RFC2822 standard consists of header fields and, optionally, a body. The body is simply a sequence of lines containing ASCII characters. It is separated from the headers by a null line (i.e., a line containing nothing except a carriage return, CR, and a line feed, LF). The header portion includes a number of fields that address and classify the message. This invention does not require the use of the RFC2822 standard. So long as there exists a method to identify essential information, the invention is applicable. However, the embodiment described herein uses the RFC2822 protocol. An example header field is: “To: John Doe<CR><LF>”.

In this example, the <CR> represents the ASCII carriage return character and the <LF> represents the ASCII line feed character. Header field names are not case sensitive. The message originator specifies the contents of many header fields. The “To:” field contains the addresses of the intended primary recipients of the message where the address of each recipient is separated by a comma. The “Cc:” field contains the addresses of the intended secondary recipients of the message. The “Subject:” field often provides a summary, or indicates the nature, of the message. Although the originator initializes all these fields, the contents of the name fields are generally required to be actual Internet addresses. On the other hand, the “Subject:” field has no specific meaning and may, in fact, be blank or contain a random arrangement of characters. Generally, the “Subject:” field contains a short title representative of the message's subject matter.

The originating computer usually communicates with an assigned mail server that routes the message to the destination mail server. Usually these mail servers utilize the Simple Mail Transport Protocol (SMTP) which is defined in RFC2821 and can be accessed at internet address “http://www.cis.ohio-state.edu/cgi-bin/rfc/rfc2821.txt”. Along the way, these mail servers add additional header fields to the message. One of these fields is the “Message-ID:” field. This field contains a unique machine-readable identifier that identifies each message and permanently remains with that message. Other headers added by the mail servers include “envelope To:” and “envelope From:” SMTP fields that establish the apparent sender address and the actual destination addresses for message routing. These take precedence over the original “message To:” and “message From:” fields and are a primary source of falsifying and disguising message addresses by spammers.

Very commonly, the destination computer is a basic workstation and does not itself include a mail server function. Thus, it cannot fully support the SMTP message routing protocol. In these cases, the destination computer periodically queries its assigned mail server and retrieves its mail messages from its mailbox on the mail server. A common protocol used to retrieve these mailbox messages from the mail server is the Post Office Protocol, version 3 (POP3). This protocol is defined in RFC1339 and can be accessed at internet address “http://www.cis.ohio-state.edu/cgi-bin/rfc/rfc1339.txt”.

An originator of a message can address a single message to many recipients by separating the addresses of the recipients with a comma. Each of these recipients may respond to the received message by sending a reply message to the same list of recipients, plus the originator. Some of these recipients may then respond to the first reply message. These reply messages are termed follow-up messages to the original message. This process facilitates dialog between the originator and the recipients, as well as between the recipients.

As mentioned above, most electronic mail programs provide a mechanism so that the recipient can reply to a message. This mechanism generally allows the reply to be sent to the originator, or to be sent to all of the original recipients in addition to the originator. These e-mail programs use the same “Subject:” field-body text as the original message but generally add a prefix indicator to the field-text portion of the subject header to indicate that the reply message relates to the subject matter of the original message. That is, the reply message is continuing the dialog initiated by the original message. The modification to the subject field is generally made by prefixing one of the following strings to the subject text: “Re:”, “ReN:”, or “Re[N]:” (where “N” is an integer). Thus, the recipients of the reply to the original message can determine that the reply is directed to ongoing dialog and not initiating a new discussion.

This process has expanded into the distribution list (or reflector) concept. In practice, those who are interested in a specific subject matter can “subscribe” to a particular distribution list. Subscribers have their e-mail address added to the list of recipients for messages sent from the distribution list or reflector. Thus, when the distribution list receives a message, it redistributes the message, using normal e-mail, to all the subscribers (recipients) of the distribution list.

When a recipient would rather not read a message, it becomes electronic junk mail—a waste of time to open, read, and discard. Because it takes the recipient's time to discard these messages, they rapidly accumulate and soon dominate the recipient's inbox. A source of junk mail can result from recipients of distribution list messages who mistakenly send Subscribe and Unsubscribe messages directly to the distribution list instead of to the list server serving the distribution list. This results in the Subscribe and Unsubscribe messages being redistributed to the recipients of the distribution list instead of being processed by the list server.

Other sources of junk e-mail are people who spam the net. Spamming can occur when someone sends a message to several distribution lists that are dedicated to topics unrelated or only marginally related to the content of the spamming message. Recipients may even receive multiple copies of the spamming message from different distribution lists. Spamming also occurs when a sender sends unauthorized messages to a large number of recipients on a mailing list, perhaps millions of recipients at a time, most of who have no interest in the message. This technique is sometimes factitiously called non-directed marketing.

In any event, spam has been described a net-wide epidemic that's getting worse exponentially. Everyone desires to be rid of spam, but not everyone agrees on what spam is. For example, a facility that removes junk e-mail may be subject to abuse by those who desire to indiscriminately censor e-mail or desire to maliciously delete e-mail addressed to another. Thus, techniques to eliminate junk e-mail or spam must take into account the concurrent need to reliably deliver desired e-mail.

One prior-art method used to limit the transmission of junk e-mail is to use a moderated distribution list, using human intervention. However, this approach delays distribution of e-mail because a human moderator must review each message before the message is distributed to the list. Further, the moderator has the sole discretion to decide which messages are distributed. Thus, discussions on topics disagreeable to the moderator create difficulties because the moderator may censor the discussion and thereby limit the effectiveness of the discussion group. Such a moderated approach is clearly not applicable to individual e-mail recipients on their home computers.

The prior-art has also partially addressed the junk mail problem by enabling the creation of recipient-modifiable “filters” that attempt to ignore e-mail messages that the recipient does not desire to view. These filters examine each message for some condition or set of conditions. If the filter detects the prescribed condition in the message, the filter performs an operation on that message. These filter operations generally include a delete operation. Thus, the recipient can remove undesired messages from incoming e-mail without intervention. A really serious problem with filters is that they are difficult for non-technical users to use and often require significant debugging. Additionally, the recipient must remember to deactivate the filter at some later date to be able to read future desired messages that happen to satisfy the current conditions for being filtered. Another problem with the filter approach to removing junk e-mail is that junk e-mail usually does not have a consistent characteristic that the filter can detect. This means that the recipient must constantly create new, narrowly-tailored, filters specialized for each type of junk e-mail message. Even with narrowly tailored filters, some messages that the recipient would not consider to be junk e-mail may fall within the parameters of the filter and be deleted. This occurrence is currently called a “false positive”, that is, a desired e-mail message is falsely interpreted to be junk e-mail. Such occurrences are undesirable.

Another approach that has been offered requires a header-based password be sent with each e-mail message to validate the sender of the e-mail. Some of the problems of this approach include a complex process of communicating the necessary password to the requesting sender source address, a password authentication process that itself allows junk mail to be delivered to the recipient due to the requirement that the sender must initiate the password request message and the recipient must receive it (a major problem because many spammers continually change their source address and could spam the intended recipient simply by continuing to send additional password request messages from different source addresses), the requirement that the password remain permanently associated with the authorized source address, the requirement that the password be included in sender messages, and that special modifications are required to existing e-mail client software to provide the necessary password header format for the sender messages.

### BRIEF SUMMARY OF THE INVENTION

The present invention solves the problems of the above-described systems and simplifies a recipient's use of e-mail by utilizing a novel automatic feedback mechanism to identify and authorize receipt of e-mails from only those senders that have been specifically authenticated by the recipient. Once a source address is authorized, all subsequent e-mails from that source address are automatically accepted, without the requirement for continuing use of a password or other authentication method for that source address. The required authentication information is requested by the intended recipient, not the sender, thereby eliminating a vulnerability of prior password-type systems that allowed the sender-initiated password request message itself to be used to send junk e-mail to an intended recipient. The present invention implements this functionality transparently, requiring no change to existing e-mail client software or hardware.

While most conventional spam-removing techniques presume that the recipient desires every received message, unless proven to be spam, this invention presumes every received message to be spam, unless authenticated as desirable by the recipient. This “It's spam unless proven otherwise.” concept makes the present invention superior to previous methods because it does not require or use predetermined lists, content-scanning or trusted-recipient classifications to filter e-mail, each of these techniques being far less than 100% accurate and requiring continuing refinement and periodic database updating. Yet it also provides a very high probability that all desired e-mail will be delivered to the intended recipient. It puts the recipient in control of his or her e-mail.

Accordingly, the present invention provides a method, a computer program product and a system to solve the problem of receiving undesired e-mail (junk mail or spam). A database of trusted e-mail source addresses, the authentication database (ADB), is created for each intended recipient e-mail address on a client computer. All incoming e-mail source addresses are compared to this database and only e-mails originating from authorized senders are allowed to pass to the e-mail client application. E-mails from senders previously designated as blocked are automatically deleted. E-mails from unauthorized (or unknown) senders are temporarily stored in a quarantine storage area and a Request for Authorization (RFA) message is automatically sent back to the sender. The RFA message asks the sender to provide an authorization key in a Request for Authorization Reply (RFAR) message, which varies depending on the method of authorization in use. If the sender replies with a RFAR having the correct key, the original e-mail is passed to the recipient's e-mail application client and the sender's source address is stored in the recipient's authentication database, enabling all subsequent messages from that source address to be passed directly to the e-mail application client. If the sender replies with a RFAR having the wrong key, the process may repeat until such a time as the source address is deemed to be unauthorized, whereupon the original quarantined e-mail is ignored and eventually deleted.

### BRIEF DESCRIPTION OF THE DRAWINGS

The objects, features and advantages of the system of the present invention will be apparent from the following description in which:

FIG. 1 illustrates the major parts of a computer that can be configured to support the use of an e-mail system.

FIG. 2 illustrates the overall structure of a typical e-mail system and its relationship to the present invention.

FIG. 3 is an overview of the operation of the invention in accordance with the preferred embodiment.

FIG. 4a, 4b, 4c are flow charts describing an implementation of the present invention in accordance with the preferred embodiment.

FIG. 5 is an illustration of a possible user E-mail Authorization Configuration screen displayed by a computer program product in accordance with the present invention.

FIG. 6a, 6b, 6c are illustrations of possible “Request for Authorization” (RFA) auto-reply messages generated by the computer program product implementing the present invention when a received e-mail address is as yet unauthorized.

FIG. 7a, 7b, 7c includes illustrations of three possible e-mail messages that may occur during the process of validating a new sender in accordance with the present invention.

FIG. 8 is an illustration of a possible configuration screen that may be used during the authorization phase when the “Ask Me” popup option has been selected when implementing the present invention.

FIG. 9 is an illustration of a possible configuration screen for the Quarantine Database that serves as a temporary holding area for received e-mail messages during the authentication process when implementing the present invention.

### NOTATIONS AND NOMENCLATURE

ADB—Authentication Database; a list of authorized e-mail source addresses used by an e-mail user; the validated address database; also, authorization database.

ARPA Internet Text Messages—the standard for constructing internet e-mail messages, as defined in RFC2822.

Authenticate—to accept as a trusted source; to authorize; to validate.

Authentication Information—a password, a completed form or any specified information necessary to authenticate an e-mail source address.

Block—to prevent receipt from an undesirable or untrusted source.

Client computer—a computer serving end users and running user application programs.

Client—a user; a user of a client computer.

Computer—a device that performs digital processing, provides digital storage and has input/output capability; includes items such as personal computers (PC), personal digital assistants (PDA), server computers, cell phones, and the like.

Distribution list—a list of e-mail addresses that messages are sent to; also, an e-mail recipient that receives e-mail and forwards that e-mail to subscribers to the distribution list; a computer application called a list server often manages a distribution list; a distribution list is often called a mailing list.

DSN—Delivery Status Notification; an e-mail message returned to sender informing sender of non-delivery of an e-mail message, including the reason for non-delivery.

DSNR—Delivery Status Notification Reply; an e-mail message sent to the originator of a DSN, instructing originator of the need to access a specific URL to obtain instructions on how to authenticate the source address of the original non-delivered message.

E-mail—messages communicated electronically between two or more computers or computer-like devices; also, email; raw e-mail.

E-mail system—electronic mail system; also, email system; a system of computers, or other computer-like devices, generally connected by a network that allow an originator (being a user of a first computer) to compose and send data making up a message to a recipient (being a user of either the first computer or of a second computer).

Flag—a discrete indicator used as an alert that is reset upon the completion of the indicated operation.

Graphical User Interface (GUI)—a user interface that allows a user to interact with a computer display by pointing at selectable control areas on the display and activating a command or computer operation associated with the selectable control area; GUIs are well known in the art.

Inbox—an area of file storage on a client computer or mail server used to store e-mail messages that have not been viewed by a recipient; also known as mailbox or destination address.

Junk Mail—any undesired or unsolicited e-mail; also known as spam.

MIME—Multipurpose Internet Message Extension; the MIME protocol allows modification of the standard US-ASCII e-mail message formats to include video, audio, graphic, as well as other customized formats.

Originator—a computer user or computer application program that composes an e-mail message and presents the message to the computer's e-mail system for transmission to one or more recipients.

Pane—an area in a window where an application may draw graphics (i.e., text, pictures, movies, etc.).

Pointing device—a device that is responsive to a computer user's input that moves an indicator on a computer display screen; such an indicator has an active point such that if the pointing device is activated (for example, by a button push for a mouse device), a command associated with the selectable control area covered by the active point is invoked; graphical user interfaces generally use pointing devices.

POP3— Post Office Protocol, version 3; a protocol used by client computers to query mail servers for new mail; defined in RFC1339.

Recipient—a computer user or computer application program having an e-mail address that an originator can send an e-mail message to.

Selectable control area—an area on a computer display that is sensitive to activation of a pointing device; activation of the pointing device over the selectable control area invokes a command or computer operation associated with the selectable control area; most computer systems that provide a Graphical User Interface (GUI) also provide other methods for invoking these commands or computer operations such as keyboard function keys or command lines.

Server—a computer that services (serves) multiple client computers or other server computers.

Sender—the author of an e-mail message sent to an intended recipient; the message originator.

SMTP—Small Message Transfer Protocol; a standard mail server-to mail server routing protocol; defined in RFC2821.

Source Address—the e-mail address of the originator of a message.

Spam—an especially obnoxious form of junk mail; often called non-directed marketing or advertising.

Spamming—the act of sending an e-mail message to multiple distribution lists even though the message does not fit the distribution lists' subject matter; in general, spamming is the sending of undesired or unsolicited e-mail messages to very large groups of recipients without their consent, usually using purchased or otherwise obtained e-mail address lists; it is not unusual for a single spam mailing to include several million intended recipients.

Spammers—source addresses or senders that send spam.

Tag—a discrete indicator associated with an object.

Text String—ordered computer data in a computer that represents text; one common representation of a text string is a sequence of eight bit bytes each containing an ASCII representation of a character; such a sequence is often terminated by a byte whose value is zero or by having a leading value to indicate the length of the string; one skilled in the art will understand that there exist many methods for storing text strings beyond the ones mentioned here.

URL—Uniform Resource Locator; the address of a resource or file available on the internet.

User—a person who uses a computer; also, end user.

Window—an area, usually rectangular, on a computer display screen controlled by an application.

### DETAILED DESCRIPTION OF THE INVENTION

Overview

The present invention is directed to a method, system and computer program product for preventing delivery of undesired e-mail (spam or junk e-mail) to intended recipients.

One aspect of the invention is a novel e-mail processing capability for e-mail authentication based on the sender's e-mail address. A database of trusted e-mail source addresses, the authentication database, ADB, is created for each destination e-mail address on a client computer. Each incoming raw e-mail message is intercepted and an attempt to authenticate the sender's e-mail address is performed automatically. The sender's e-mail address is compared against the ADB. If a match is found, the e-mail is authorized and allowed to pass to the user's e-mail client application. If a match is not found, the e-mail message is deemed unauthorized and the source address is staged for authentication. At the same time, this raw e-mail message is diverted to a “quarantine” storage area created for the purpose of temporarily holding unauthenticated incoming e-mail messages.

Another aspect of the invention automates the authentication process by automatically replying to an unauthenticated e-mail message with a Request For Authorization (RFA) message. The RFA asks the sender to respond to the intended recipient with a Request for Authorization Reply (RFAR) message containing the recipient's e-mail password. The sender is provided with instructions in the RFA message on how to obtain the password, if initially unknown to the sender. These instructions may consist of any or all of several techniques to convey the password back to the recipient, including requiring that sender return a password identified in a graphics (non-textual) file within the RFA message, requiring that the sender contact the recipient by phone or mail to obtain the password, or requiring some other identified means to convey the password to the recipient. Supplying the password in a graphical attachment in the RFA message makes the process of obtaining the password simple for the sender while providing resistance to automated reply techniques, such as spammers might use, since human intervention is required. Human intervention is a large deterrent to most spammers who rely on sending tens of thousands of messages quickly and automatically. If a valid password is subsequently received at the client computer from the sender's RFAR message, the “quarantined” raw e-mail message is allowed to pass to the e-mail client application as an authenticated message. At the same time, the authenticated sender e-mail address is added to the recipient's ADB. If the password is not returned to the intended recipient or is found to be invalid, the process will iterate N times, where N is an arbitrary number, and after N password failures or after an arbitrary timeout period, the “quarantined” raw e-mail message and all subsequent messages from that source will be ignored and eventually deleted.

Another aspect of the invention also automates the authentication process by automatically replying to an unauthenticated e-mail message received by the recipient. In this case, the RFA message includes a blank form and asks the sender to respond with a RFAR containing the completed form. If the completed form is subsequently received and validated, the original raw e-mail message is allowed to pass to the e-mail client application as an authenticated message. At the same time, the authenticated sender e-mail address is added to the recipient's ADB. If the returned form is not received by the intended recipient or found to be incomplete or invalid, the process will iterate M times, where M is an arbitrary number, and after M form return failures or after an arbitrary timeout period, the “quarantined” raw e-mail message and all subsequent messages from that source will be ignored and eventually deleted.

Another aspect of the invention implements the authentication process by presenting the unauthenticated e-mail message directly to said recipient, allowing said recipient to personally decide whether to authenticate or block that sender's address or even to authenticate or block the sender's entire domain. If authenticated by the recipient, the sender's address is added to the recipient's ADB. If rejected, said sender's address is permanently blocked. A subsidiary mode of this aspect of the invention allows the recipient to manually review the authentication database off-line to revise the status of any previously processed sender address.

Another aspect of the invention provides for storing a duplicate copy of each intended recipient's ADB on the mail server containing the recipient's mailbox. This copy exists on the mail server as an e-mail message communicated from the intended recipient back to himself or herself and stored in the intended recipient's mailbox. The server duplicate copy can be periodically replaced by way of an “update server ADB” e-mail message from the recipient containing an updated version of the ADB. This insures synchronization of the authentication database for the intended recipient on both the client computer and the mail server. Further, the duplicate copy of the recipient's ADB can be downloaded to the intended recipient at any time, for example to replace a damaged or destroyed database on the client computer as may occur after a catastrophic event, such as failure and repair of the client computer. An important further advantage of this database duplication technique, is that the duplicate copy of the recipient's ADB can be downloaded to multiple client computers from the mail server, thereby allowing the intended recipient to receive his or her junk mail-protected incoming messages from any or all of the client computers receiving the ADB download, as long as the present invention is installed on each of the client computers.

Another aspect of the invention provides a process that will enable the authentication of legitimate e-mail source addresses that are not programmed to accept incoming messages. Such legitimate source addresses include internet web site department stores or auction sites that respond to purchasers or bidders with confirmation messages that cannot be responded to. For such cases, the postmaster responsible for such a source address that has been sent a RFA, responds to the intended recipient with a Delivery Status Notification (DSN) message informing the intended recipient of the non-deliverable status of the RFA. The intended recipient responds to the postmaster with a Delivery Status Notification Reply (DSNR) message, informing the postmaster of the problem status of the source address and instructing the postmaster to contact a specified internet URL, at which internet site instructions are provided on how to provide the required authentication information to the intended recipient. These instructions may request, for example, that the sender source address in question provide the required authentication information, obtained from the intended recipient at the time the recipient initially enrolled with the web site, within another initial e-mail message sent from the source address to the intended recipient, an example being, within the message content of a custom Multipurpose Internet Message Extension (MIME). This authentication process need only be done once for each such non-respondable source address.

Still another aspect of the invention provides for its installation and use on a client computer, thereby preventing receipt of undesirable e-mail for all users of that client computer, or alternatively, for its installation and use on a server computer, thereby preventing receipt of undesirable e-mail for all users of all client computers being serviced by that server computer.

Operating Environment

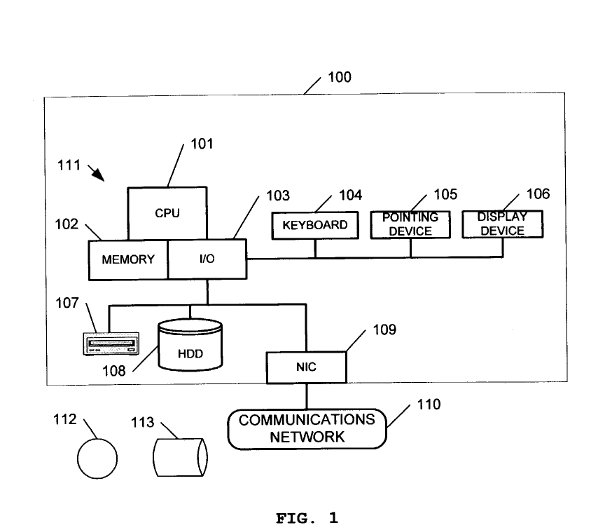

Some key elements of a computer system 100 configured to support an e-mail system are shown in FIG. 1 wherein a processor 111 is shown, having an Input/Output (“I/O”) section 103, a Central Processing Unit (“CPU”) 101 and a memory (RAM) section 102. The I/O section 103 is connected to a keyboard 104, a Hard Disk Drive (HDD) 108, a Network Interface Controller (“NIC”) 109 to provide access to a communications network 110, a display device 106, a pointing device 105 and a CD-ROM drive unit 107. The CD-ROM unit 107 can read any storage medium 112 that typically contains computer programs 113 and data. The CD-ROM 112, the hard disk drive 108, and the Memory 102 comprise a file-storage mechanism. One skilled in the art will understand that the file-storage mechanism may comprise read only memory, RAM or other storage technology that allows a computer to access data. Such a computer system is capable of executing e-mail applications that embody the invention.

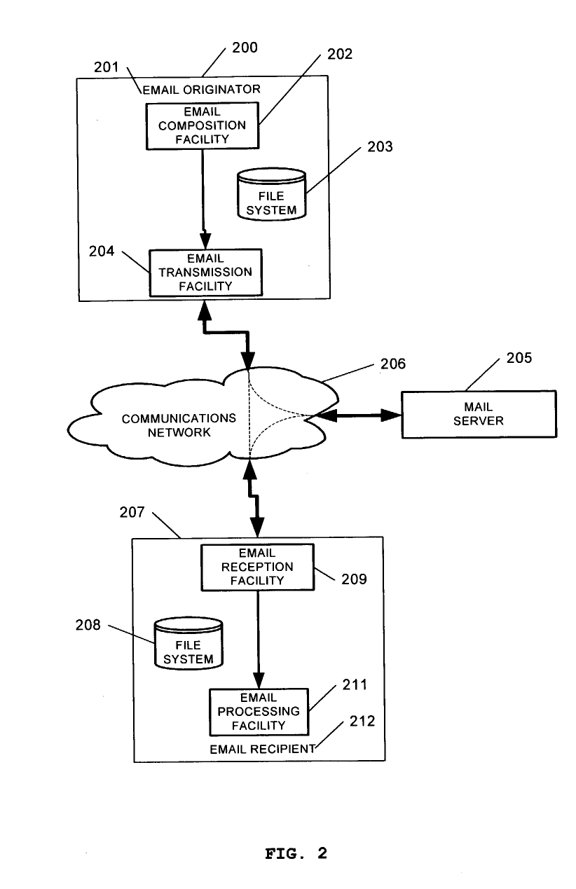

FIG. 2 provides a conceptual overview of the major elements of an electronic mail system, such as is typically used to pass both desirable e-mail and junk e-mail, and its relationship to the present invention. The e-mail system from an originator's 201 point of view is shown in 200 as an e-mail client computer and contains a composition facility 202 that allows the originator to compose an e-mail message, including specifying a subject and a recipient's e-mail address. This e-mail message is passed to the e-mail transmission facility 204 where it is sent to the intended recipient's address. The message is sent to the recipient by traveling across a communications network 206. If the intended recipient is on the same computer as the originator, the e-mail message generally does not travel across a communications network 206. Optionally, a copy of the message can be stored in the originator's file-storage system 203.

An e-mail system from a recipient's 212 point of view is shown in 207 as an e-mail client computer and contains an e-mail reception facility 209 and an e-mail processing facility 211 to identify, process and store the e-mail messages in the recipient's mail inbox and allow the received messages to be viewed or otherwise accessed by the recipient. An e-mail processing facility 211 normally uses any one of a number of commercial client application programs to perform its functions. The recipient's inbox is generally maintained in a file-storage system 208. E-mail messages arriving at the e-mail reception facility 209 usually arrive by way of a local mail server 205 from the communications network 206. The mail server 205 provides routing support for incoming messages and also supplies mailboxes for the multiple e-mail clients it serves. This reduces the workload on the individual recipient computers 207 and allows incoming messages to be put into the client's mailbox even when the client computer is offline.

The present invention described herein may be installed individually on each client computer 207 having e-mail recipients 212 desiring not to receive junk e-mail. Alternatively, the present invention may be installed on the mail server 205, in which case the invention can be configured to service all client computers 207 having e-mail recipients 212 desiring not to receive junk e-mail.

Operational Overview

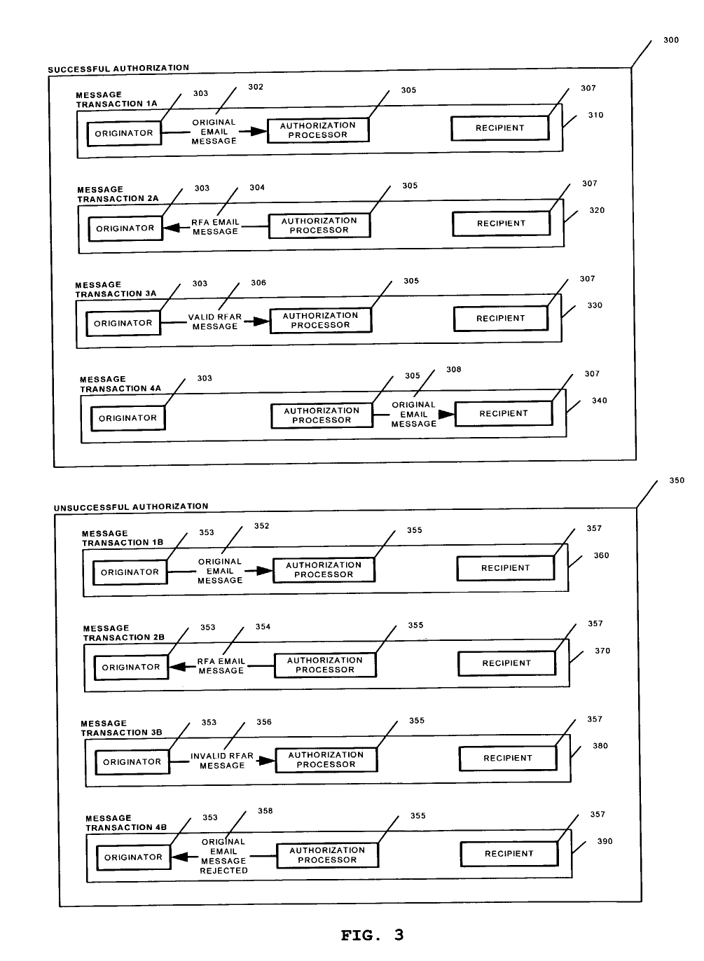

FIG. 3 is an overview of the invention's authorization processes. Shown are two sets of four message transactions 300, 350. The first set of four message transactions 310, 320, 330, 340 describe the messaging sequence of a successful authorization 300. The four message transactions occur sequentially in time 310, 320, 330, 340. The first transaction 310 shows an “original” e-mail 302 sent from the originator 303 to the recipient 307. The authorization processor 305 intercepts the message 302. In this case, the e-mail address of the originator 303 is unknown to the authorization processor 305. The authorization processor 305 automatically replies 320 to the originator 303 with a “Request for Authorization” (RFA) message 304. The RFA message requests that the originator 303 reply with an authorization key, validating the originator 303 as an authorized e-mail-sending source. The originator 303 replies 330 with the correct “Request for Authorization Reply” (RFAR) message 306 and the “original” e-mail 302 is passed 340 to the recipient 307 as indicated by the message transaction labeled 308.

The second set of four message transactions 360, 370, 380, 390 describe the messaging sequence of an unsuccessful authorization 350. The four message transactions occur sequentially in time 360, 370, 380, 390. The first transaction 360 shows an “original” e-mail 352 sent from the originator 353 to the recipient 357. The authorization processor 355 intercepts the message 352. In this case, the e-mail address of the originator 353 is unknown to the authorization processor 355. The authorization processor 355 automatically replies 370 to the originator 353 with a “Request for Authorization” (RFA) message 354. The RFA message requests that the originator 353 reply with an authorization key, validating the originator 353 as an authorized e-mail-sending source. The originator 353 replies 380 with the incorrect “Request for Authorization Reply” (RFAR) message 356 and the “original” e-mail 352 is rejected 390 and notification is sent back to the sender 353 as indicated by the message transaction labeled 358.

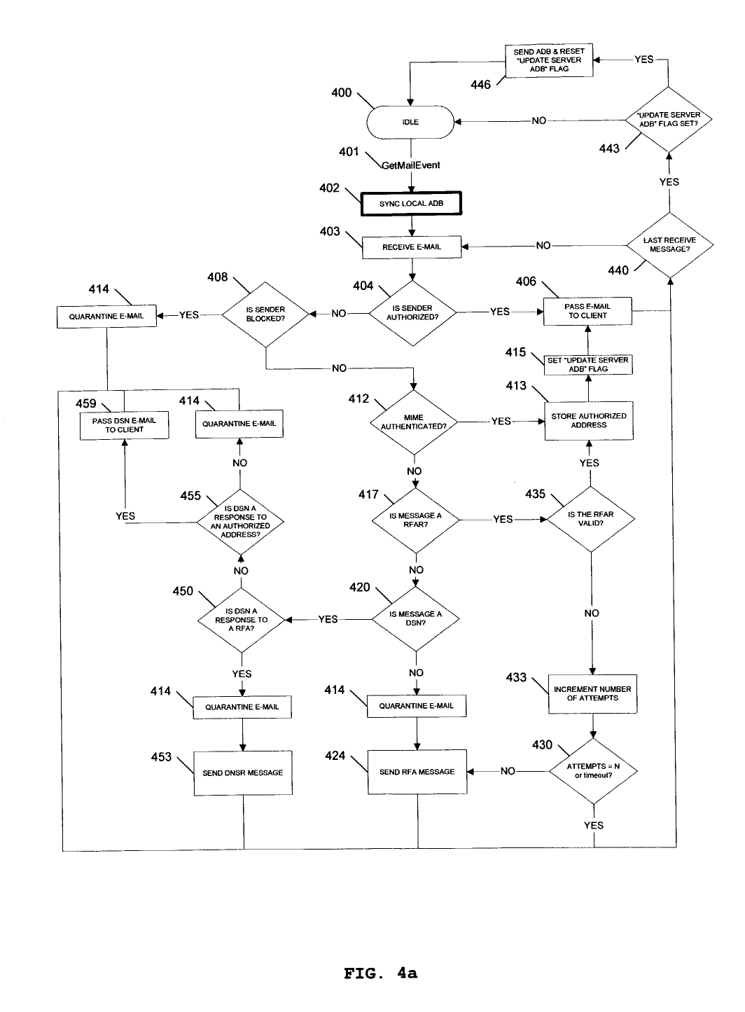

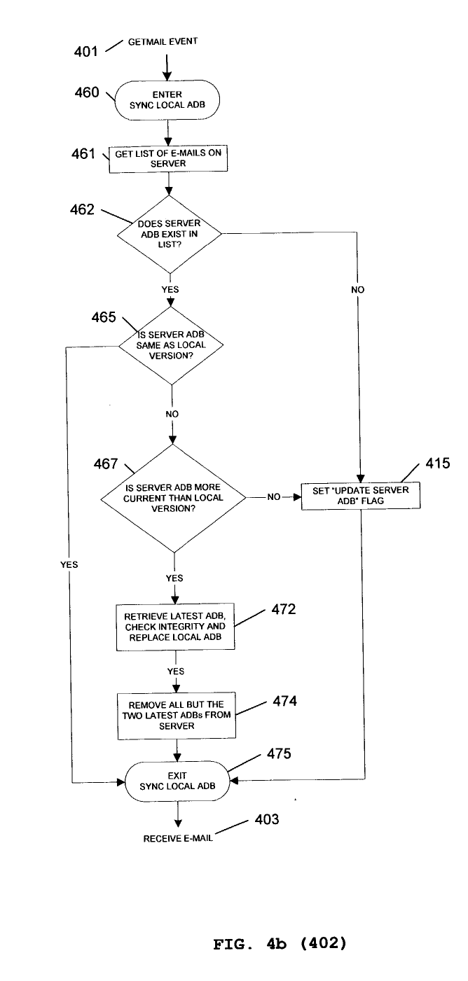

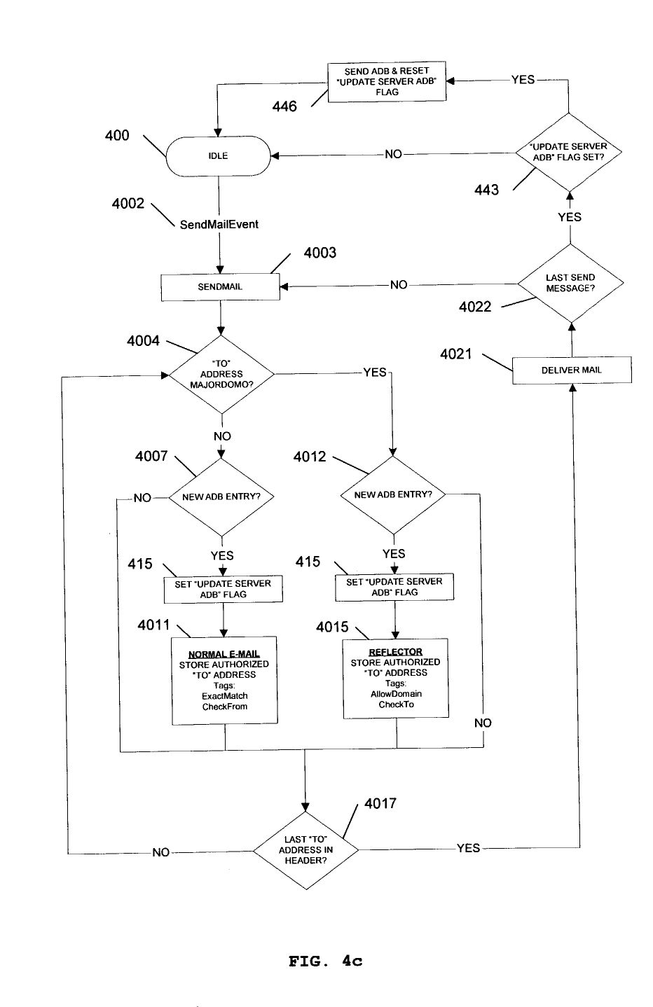

FIGS. 4a, 4b, and 4c are flow charts depicting and implementation of the present invention in accordance with the preferred embodiment. FIG. 4a illustrates the process of authorizing incoming e-mail addresses implemented by a computer program in accordance with the present invention. An idle 400 condition is assumed at the start. A GetMail event 401 initiates the process of retrieving incoming mail. Synchronization of the authentication database (ADB) 402 initiates this process and is described separately in FIG. 4b. An incoming e-mail is received 403 and the sender's address is checked 404 against a database of authorized senders, ADB. If a match is found, the e-mail message is passed to the e-mail application client 406. If a match is not found the sender's address is checked 408 against a database of blocked senders. If a block match is found, the e-mail message is quarantined 414. If the sender's address is neither authorized nor blocked, the sender's address is checked to see there is a valid MIME authorization 412 in the e-mail message. If a match is found, the sender's address is added to the ADB 413, an “update server ADB” flag is set 415 and the e-mail is passed to the client 406. If a match is not found, the e-mail is checked to see if it is a Request For Authorization Reply (RFAR) 417. If it is a RFAR, the validity of the RFAR is checked 435. If valid, the sender's address is added to the ADB 413, an “update server ADB” flag is set 415 and the e-mail is passed to the client 406. If the e-mail is an invalid RFAR, N RFA attempts will be made 433, 430, 424 where N is an arbitrary number. After N validation failures or after an arbitrary timeout period 430, the original message is ignored and eventually drops out of the quarantine storage area 414. If the message is not a RFAR, the sender's address is checked see if it is a Delivery Status Notification (DSN) 420. If it is not a DSN, the message is quarantined 414 and a RFA message is sent 424 to the sender address. If it is a DSN, the message is checked to see if it is a response to a RFA 450. If the DSN is a response to a RFA, the message is quarantined 414 and a Delivery Status Notification Reply (DNSR) message is sent 453 to the sender address. If the DSN message is not a response to a RFA, the message is checked to see if it is a response to an already authorized address 455. If the DSN is not a response to an already authorized address, the DSN e-mail message is viewed as suspicious and quarantined 458. If the DSN is a response to an already authorized address, the DSN e-mail message is passed to the client 459. After each message passes through this decision matrix, the GetMail event checks to see if there are any more incoming messages 440. If there are more incoming messages, the process returns to receive the next message 403. If there are no more messages, the process checks to see if the “update server ADB” flag 443 has been set. If it has not been set, the system returns to the idle state 400. If it has been set, a command to update the server ADB is sent and the “update server ADB” flag is reset 446. The system then returns to the idle state 400.

FIG. 4b 402 illustrates the synchronization process between the local user authentication database (ADB) and the duplicate copy on the server that enables both ADBs to be synchronized images of each other. The synchronization process is entered 460 from the GetMail event 401. Upon entering the process, the local client retrieves a list of e-mails on the mail server 461. It then checks to see whether the server has an e-mail message containing the ADB 462. If it does not have this e-mail message, the “update server ADB” flag is set 415 and the client exits 475 and proceeds to receive e-mail 403. If the server has an e-mail containing the ADB, it checks to see if the server ADB version is the same as the local version 465. If it is the same, the client exits 475 and proceeds to receive e-mail 403. If the ADB versions are not the same, the more current version is determined 467. If the local version is more current, the “update server ADB” flag is set 415 and the client exits 475 and proceeds to receive e-mail 403. If the server version is more current, the latest server version is retrieved by the client 472 to replace the existing local ADB after its integrity is confirmed. Then, all but the two most current server ADB versions are deleted 474 and the client exits 475 and proceeds to receive e-mail 403.

FIG. 4c illustrates outgoing message flow and the process of adding outgoing message addresses, with appropriate tags, to the user authentication database (ADB). An idle condition is assumed at the start 400. A SendMail Event 4002 initiates the process by sending an outbound message 4003. The message is checked to see if the “To:” address is “majordomo” 4004. If it is, the address is checked to see if it requires a new ADB entry 4012. If a new ADB entry is not required, the process moves to decision box 4017. If a new ADB entry is required for “majordomo”, the “update server ADB” flag is set 415, reflector tags are added 4015 and the process moves to decision box 4017. If the “To” address is not “majordomo” 4004, then normal e-mail processing occurs. The “To:” address is checked to see if a new ADB entry is required 4007. If it isn't, the process moves to decision box 4017. If the “To” address requires a new ADB entry, the “update server ADB” flag is set 415, normal e-mail tags are added 4011 and the process moves to decision box 4017. Decision box 4017 checks to see if there are more “To:” addresses in the e-mail header. If there are more addresses, the process returns to the “To:” address decision box 4004 and the next “To:” address in the header is processed. If there are no more “To:” addresses, the message is sent 4021. After each message passes through this decision matrix, the SendMail event checks to see if there are any more outgoing messages 4022. If there are more outgoing messages, the next message is processed 4003. If there are no more outgoing messages, the process checks to see if the “update server ADB” flag 443 has been set. If it has not been set, the system returns to the idle state 400. If it has been set, a command to update the server address database is sent and the “update server ADB” flag is reset 446. The system then returns to the idle state 400.

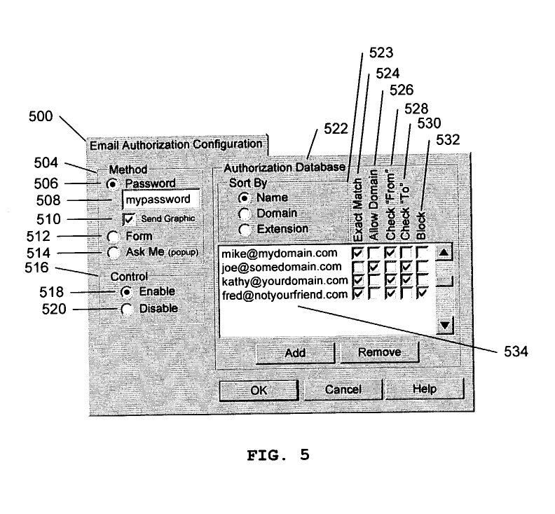

FIG. 5 is an illustration of a user E-mail Authorization Configuration screen 500 displayed by a computer program in accordance with the present invention. E-mail may by authorized by the recipient using one of three authentication methods 504.

The first authentication method is “Password” authorization 506. When “Password” authorization 506 is selected and an unauthorized e-mail message is received by the recipient, an RFA message is automatically sent back to the sending source of the unauthorized message asking the originator to respond with a RFAR containing the e-mail password 508. This e-mail password 508 may be secret, meaning the originator is required to have prior knowledge of the e-mail password 508, or the originator may contact the recipient by means other than e-mail to obtain the e-mail password 508. The password may also be transmitted to the originator within the RFA message in the form of a “graphic” attachment 510. The graphic attachment is a non-textual representation of the password. The originator must open the graphic attachment of the RFA message and read (or interpret) the password. Once the password is known the originator must reply with a RFAR message containing the known password. Once the RFAR is received and validated, the original and all subsequent e-mail will be passed directly to the e-mail client application.

The second authorization method is “Form” authorization 512. When “Form” authorization 512 is selected and an unauthorized e-mail message is received by the recipient, a RFA message, including a blank form, is automatically sent back to the sending source of the unauthorized message asking the originator to respond by filling out and returning the form as a RFAR message. This form may require the originator to supply information such as, but not limited to: name, company name, address, phone number, or mutually-known data. Once the RFAR is received and validated with the completed form information, the original and all subsequent e-mail will be passed directly to the e-mail client application.

The third authorization method is “Ask Me” or “popup” authorization 514. When “Ask Me” authorization 514 is selected and an unauthorized e-mail message is received by the recipient, a popup screen is presented to the user identifying the source and content of the unauthorized e-mail. The user is then allowed to accept or reject the unauthorized message. If the user accepts the unauthorized message, it becomes authorized and all subsequent e-mail from that source will be passed directly to the e-mail client application.

Authorization Database 522:

The Authorization Database 522 contains e-mail addresses of all authorized e-mail sources 534. The database may be sorted by name, domain or extension 523. Each Authorization Database 522 entry has the following tags: Exact Match 524, Allow Domain 526, Check “From” 528, Check “To” 530 and Block 532. These tags tell the authorization processor what to look for when validating the source of an e-mail and are described below:

Exact Match 524:

Instructs the authorization processor to validate the entire e-mail address of the sending source e-mail address. For example, mike@mydomain.com

Allow Domain 526:

Instructs the authorization processor to validate only the domain portion of the sending source e-mail address. For example, anyone from somedomain.com

Check “From” 528:

Instructs the authorization processor to validate using “From” address found in the e-mail header.

Check “To” 530:

Instructs the authorization processor to validate using “To” address found in the e-mail header.

Block 532:

Instructs the authorization processor to block any e-mail from this e-mail address.

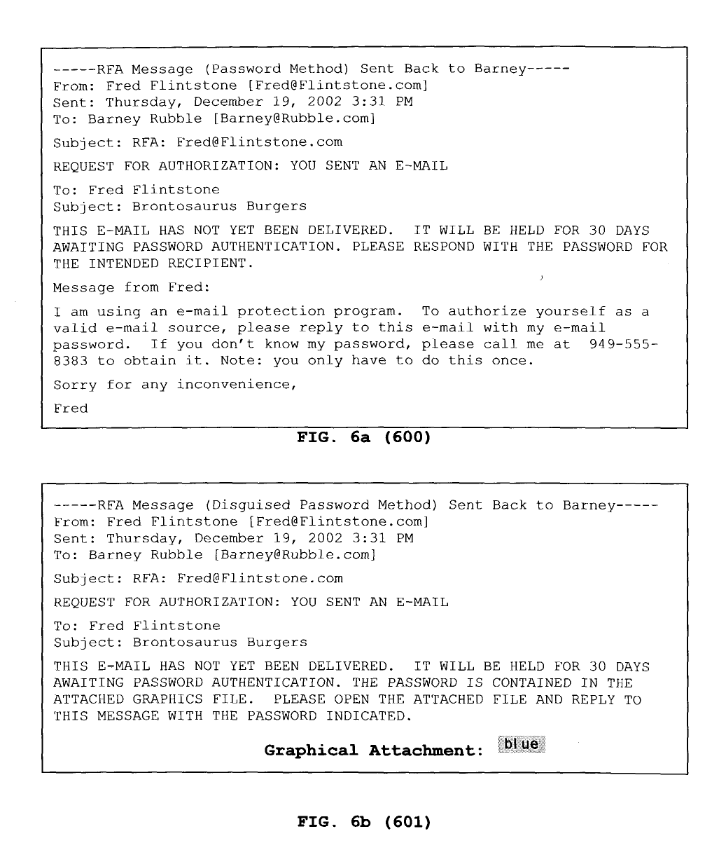

FIG. 6 includes illustrations of three possible “Request for Authorization” (RFA) auto-reply messages 600, 601, 602 generated by a computer program implementing the present invention when a received e-mail address is as yet unauthorized. The RFA message shown in FIG. 6a 600 illustrates a possible configuration screen when the “Password” authorization option has been selected and the sender must return the password without the password being hidden in the RFA message, requiring the sender to obtain it by other means such as telephoning the recipient. The RFA message shown in FIG. 6b 601 illustrates a possible configuration screen when the “Password” authorization option has been selected and the sender must return the password contained within a graphics file attached to the RFA, requiring human intervention and interpretation to obtain the password. The RFA message shown in FIG. 6c 602 illustrates a possible configuration screen when the “Form” authorization option has been selected. The sender must fill out the form with the requested information and send it back to the original e-mail recipient for validation.

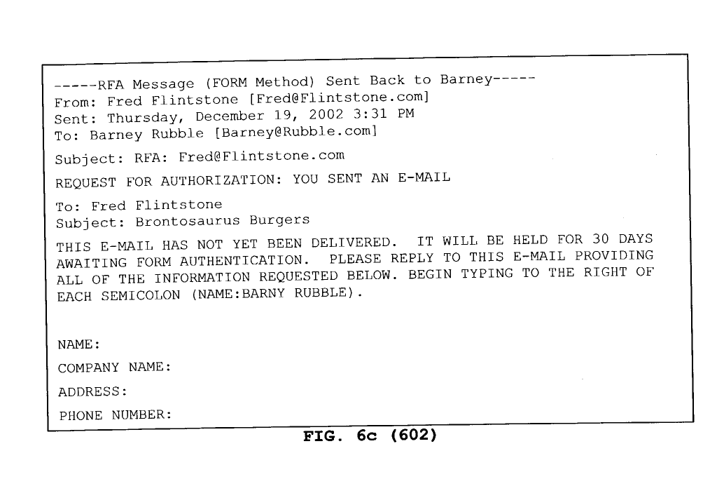

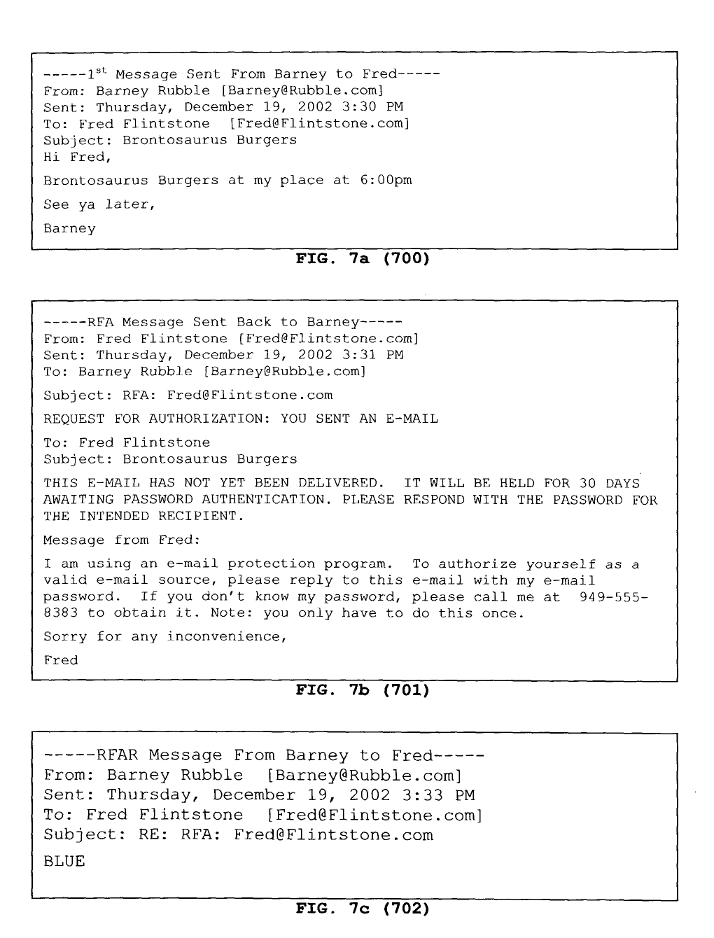

FIG. 7 includes illustrations of three possible e-mail messages that may occur during the process of validating a new sender. The first message is shown in FIG. 7a 700 and is the original message from the sender to the recipient. The second message is shown in FIG. 7b 701 and is the RFA from the recipient sent back to the original sender requesting a password response. The third message is shown in FIG. 7c 702 and is the RFAR containing the password response from the original sender, in this case with the password, BLUE.

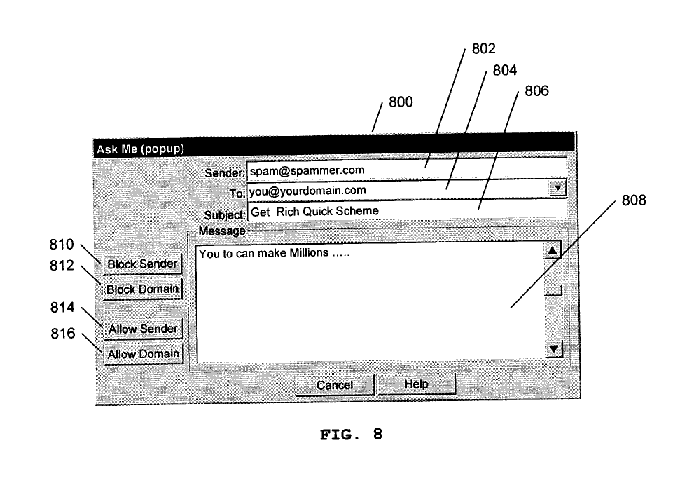

FIG. 8 is an illustration of a possible configuration screen 800 that may be used to authenticate a sender address when the Ask Me 514 authorization option has been selected. Sender information is presented to the recipient and includes the Sender's address 802 contained in the original e-mail, the addressee 804 identified in the original e-mail, the Subject 806 header of the original e-mail and the original message text 808. From this information the recipient has the option to block the sender 810, block the sender's entire domain 812, authorize (allow) the sender 814 or authorize (allow) the sender's entire domain 816.

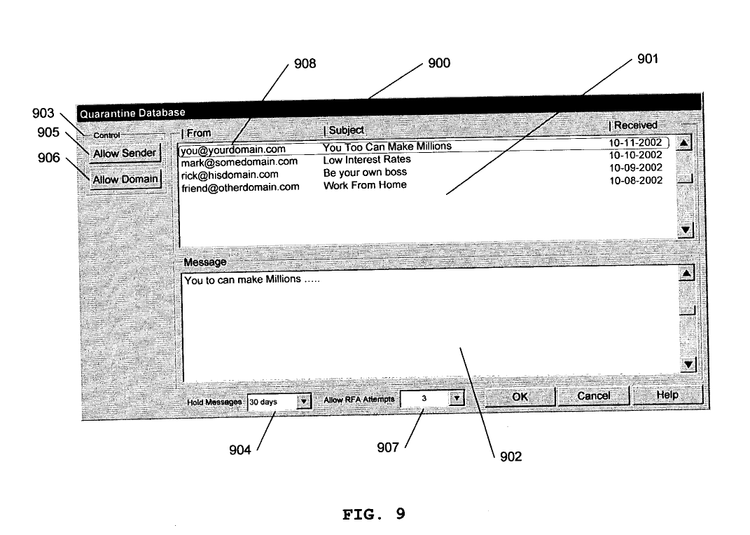

FIG. 9 is an illustration of a possible configuration screen 900 that can be used to identify and control the Quarantine Database that serves as the temporary storage for incoming e-mail messages during the authorization process. This screen identifies each quarantined message sender as well as the Subject header and the date Received 901 for each message. It also allows the recipient to view the Message content of each quarantined message 902. This screen also allows the recipient to select the maximum quarantine time period 904 and the number of RFA attempts 907 before invalidation of the sender addresses 908 in the quarantine database. This screen also allows the recipient, if desired, to manually control 903 the status of each quarantined message by first selecting it from the indicated message list 901, and then either authorizing (allowing) the sender address 905 or authorizing (allowing) the entire sender domain 906.

The “Allow Sender” 905 and “Allow Domain” 906 buttons can also be used to authorize desired source addresses and domains not programmed to respond to RFARs and not yet configured to request the authentication password from the recipient as part of the subscriber website enrollment process. This password, when configured, could be included in the MIME part of an authentication message from said non-respondable source address, for example, as discussed in FIG. 4a. Two examples of such source address authorizations could be:

Web site department stores, for purchase receipt messages to buyers, and

Auction sites, for item bid confirmations to bidders.

While the present invention has been particularly described with reference to the preferred embodiments, it should be readily apparent to those skilled in the art that changes and modifications in form and details may be made without departing from the spirit and scope of the invention. Accordingly, the scope of the invention should be determined not by the embodiments illustrated but by the appended claims and their legal equivalents.

What I claim as my invention is:

1. An authentication method for preventing receipt of undesirable (junk or spam) electronic mail (e-mail) by an intended recipient of e-mail messages, the steps comprising:
(a) providing an authentication database comprising a plurality of e-mail addresses of trusted e-mail source addresses from whence e-mail is acceptable;
(b) receiving a raw e-mail message from a sender by an intended recipient, said raw e-mail having a source address;
(c) comparing said source address to said authentication database; and
(d) when said comparing step (c) fails to match said source address to a trusted e-mail address in said authentication database, automatically responding to said sender at said source address with a message requesting additional authentication information therefrom.

2. The authentication method, as recited in claim 1, wherein said automatically responding step (d) comprises the sub-step of retaining said raw e-mail message in a quarantine storage area.

3. The authentication method, as recited in claim 1, the steps further comprising:
(e) when said comparing step (c) matches said source address to a trusted e-mail address in said authentication database, processing said raw e-mail message and forming an authenticated message therefrom for presentation to said intended recipient.

4. The authentication method, as recited in claim 2, the steps further comprising:
(f) upon receipt of the requested authentication information of step (d) from said source address, if said authentication information is determined to be valid, automatically adding said source address to said authentication database and processing said raw e-mail message stored in said quarantine storage area and forming an authenticated message therefrom for presentation to said intended recipient;
(g) upon receipt of the requested authentication information of step (d) from said source address, if said authentication information is determined to be invalid, automatically excluding said source address from said authentication database and ignoring said raw e-mail message stored in said quarantine storage area.

5. The authentication method as recited in claim 4, wherein said message requesting additional authentication information of step (d) comprises a Request for Authorization (RFA) message and wherein said response message of steps (f) and (g) from said source address comprises a Request for Authorization Reply (RFAR) message.

6. The authentication method as recited in claim 5, wherein said RFA message comprises instructions for obtaining said authentication information to be included in said RFAR message, said instructions comprising at least one from a group of methods:
(h) requesting said sender at said source address to send a RFAR message to said intended recipient comprising a password contained in said RFA message;
(i) requesting said sender at said source address to send an RFAR message to said intended recipient comprising an authentication object disguised in a graphic file in said RFA message;
(j) requesting said sender at said source address to send an RFAR message to said intended recipient comprising a completed information form, a blank information form being contained within said RFA message;
(k) requesting said sender at said source address to contact said intended recipient by telephone to obtain said authentication information;
(l) requesting said sender at said source address to contact said intended recipient by mail to obtain said authentication information.

7. The authentication method as recited in claim 5, wherein a postmaster of a potentially legitimate source address that has been sent a RFA message, said source address having been programmed to ignore incoming mail (non-respondable source address), responds to said intended recipient with a Delivery Status Notification (DSN) message informing said intended recipient of the non-deliverable status of said RFA message, whereupon said intended recipient responds to said postmaster with a Delivery Status Notification Reply (DSNR) message, informing said postmaster of the requirement for said non-respondable source address to be authenticated and instructing said postmaster to contact a specified internet web site, at which internet web site instructions are provided on how to communicate the required authentication information to said intended recipient, such instructions also requesting that the sender at said non-respondable source address include said required authentication information within an e-mail message to be sent from said non-respondable source address to said intended recipient.

8. The authentication method as recited in claim 4, wherein said automatically responding step (d) and invalidating step (g) are performed iteratively up to a predetermined number of attempts, at which point, if said sender source address is not yet validated, said sender source address is deemed unauthorized and no further validation attempts are made.

9. The authentication method as recited in claim 2, wherein said quarantine storage area stores undelivered raw e-mail messages for a predetermined time period, said undelivered raw e-mail messages being deleted at the end of said predetermined time period.

10. The authentication method as recited in claim 4, wherein said authentication database can be modified by at least one from a group of methods: adding all source addresses within an internet domain to said authentication database, deleting all source addresses within an internet domain from said authentication database.

11. The authentication method as recited in claim 1, wherein said authentication database is stored on a client computer used by said intended recipient and a duplicate copy of said authentication database is communicated by way of an e-mail message sent from said intended recipient back to himself and stored in said intended recipient's mailbox on a mail server servicing said intended recipient.

12. The authentication method as recited in claim 11, wherein said e-mail message containing said duplicate copy of said authentication database and stored on said mail server is periodically replaced by an update e-mail message from said intended recipient, said update e-mail message containing an updated version of said authentication database, thereby providing synchronization of said authentication database for said intended recipient on both said client computer and said mail server.

13. The authentication method as recited in claim 11, wherein said duplicate copy of said authentication database stored on said mail server is delivered to said intended recipient on said client computer to replace an unusable authentication database on said client computer, as may occur after a catastrophic event, such as failure and repair of said client computer.

14. The authentication method as recited in claim 11, wherein said duplicate copy of said authentication database stored on said mail server is delivered to a plurality of client computers from said mail server, each said client computer having the present invention installed thereon, allowing said intended recipient to receive junk mail protected incoming messages from each and all of said plurality of client computers.

15. The authentication method as recited in claim 4, wherein the present invention's processes operate transparently with an existing e-mail client application installed on a message receiving and sending client computer.

16. The authentication method as recited in claim 4, wherein the present invention is implemented on a client computer to prevent receipt of undesirable electronic mail by a plurality of intended recipients that are users of said client computer.

17. The authentication method as recited in claim 16, wherein each said intended recipient is assigned an authentication database and a quarantine storage area on said client computer.

18. The authentication method as recited in claim 4, wherein the present invention is implemented on a server computer to prevent receipt of undesirable electronic mail by a plurality of intended recipients on a plurality of client computers.

19. The authentication method as recited in claim 18, wherein each said intended recipient is assigned an authentication database and a quarantine storage area on said server computer.

20. A computer program product comprising:
(a) a computer usable storage medium;
(b) computer readable program code stored on said storage medium, providing means for enabling automatic authentication of e-mail source addresses;
(c) computer readable program code stored on said storage medium, providing means for the creation of an authentication database comprising a plurality of trusted e-mail source addresses;
(d) computer readable program code stored on said storage medium, providing means for the creation of a quarantine storage area for temporary storage of raw, undelivered e-mail messages;
(e) computer readable program code stored on said storage medium, providing means for delivery of incoming e-mail messages from authenticated source addresses to intended destination addresses;
(f) computer readable program code stored on said storage medium, providing means for preventing delivery of incoming e-mail messages from unauthenticated source addresses;
(g) computer readable program code stored on said storage medium, providing means for creating a plurality of control computer screens for intended recipient(s) to control at least one from the group: system operating parameters, automatic features of the product, modification of source addresses within the authentication database;
(h) computer readable program code stored on said storage medium, providing means for creating a plurality of display computer screens for intended recipient(s) to monitor the status of at least one from the group: authentication processing steps, authentication database, quarantine storage area, plurality of control computer screens.

21. The computer program product as recited in claim 20, wherein said computer readable program code, element (b), also incorporates at least one from the group: means for receiving e-mail messages from senders, means for comparing source addresses to said authentication database, means for sending request for authorization messages to a sender, means for receiving and processing reply messages from a sender, means for authenticating source addresses and adding them to said authentication database.

22. An electronic system to prevent delivery of undesirable (junk or spam) e-mail messages to intended recipients, comprising:
(a) a message originating computer having the capability to create and send messages to intended recipients and to reply to incoming messages from intended recipients;
(b) a communications network to route and process messages;
(c) a message receiving computer having the capability to create an authentication database comprising a plurality of trusted e-mail source addresses, receive and process incoming messages from senders, generate request for authorization messages to senders, process request for authorization reply messages from senders, authenticate source addresses and add said source addresses to said authentication database, deliver incoming e-mails from authenticated source addresses to intended destination addresses.

23. The electronic system as recited in claim 22, wherein there exists at the message receiving computer at least one from the following group: a quarantine storage area, authentication database viewing screens, control screens for e-mail message control of individual source addresses and domains, configuration screens for configuring and monitoring sender source addresses and e-mail messages.

24. The electronic system as recited in claim 22, wherein said message receiving computer is implemented as a client computer, thereby enabling automatic control of e-mail delivery to a plurality of intended recipients.

25. The electronic system as recited in claim 22, wherein said message receiving computer is implemented as a server computer, thereby enabling automatic control of e-mail delivery to a plurality of client computers and a plurality of intended recipients on each said client computer.
